(19) United States
(12) Patent Application Publication
(10) Pub. No.: US 2024/0385823 A1
(43) Pub. Date: Nov. 21, 2024

(54) PATCH GENERATION FOR FLAWS IN SOFTWARE

(71) Applicant: MICRO FOCUS LLC, Wilmington, DE (US)

(72) Inventors: Alexander Michael Hoole, Ottawa (CA); Carl Emil Orm Wareus, Stockholm (SE); Ewada Tsang, Stockholm (SE); Yixi Cecilia Huang, Stockholm (SE)

(73) Assignee: MICRO FOCUS LLC, Wilmington, DE (US)

(21) Appl. No.: 18/389,770

(22) Filed: Dec. 19, 2023

Related U.S. Application Data
(60) Provisional application No. 63/466,992, filed on May 16, 2023.

(51) Int. Cl. G06F 8/65; G06F 8/71

(52) U.S. Cl. CPC G06F 8/65; G06F 8/71

(57) ABSTRACT

Identifying and resolving weaknesses in software are common, resource-intensive tasks for many organizations. Machine-learning models are provided to automatically identify software vulnerabilities or other flaws, such as via entries in a weakness or vulnerability database, identify affected software, generate patches to resolve the vulnerabilities, and apply the patch to affected software. The patch is automatically extracted from code deltas between a software version having the weakness and a subsequent version wherein the weakness has been resolved. Other differences between the versions, not affecting the weakness, are excluded from the code deltas.

### CROSS-REFERENCE TO RELATED APPLICATIONS

The present application claims the benefit of U.S. Provisional Patent Application No. 63/466,992 filed on May 16, 2023 titled, “Patch Generation to Correct Flaws in Software,” and is incorporated herein by reference. The present application is related to and incorporates herein by reference U.S. patent application Ser. No. 18/098,582, titled “LEARNING BASED IDENTIFICATION OF VULNERABLE FUNCTIONS IN RELATION TO COMMON VULNERABILITIES AND EXPOSURES (CVE),” filed on Jan. 18, 2023, and U.S. patent application Ser. No. 16/636,293, titled “MANAGING CONTAINERS USING ATTRIBUTE/VALUE PAIRS,” filed on Feb. 3, 2020.

### FIELD OF THE DISCLOSURE

The invention relates generally to systems and methods for updating software and particularly to automatically detecting and applying fixes to address software vulnerabilities.

### BACKGROUND

Modern software applications often incorporate, in whole or in part, open-source software. Open-source software refers to computer software whose source code is freely available and can be accessed, used, modified, and distributed by anyone. This means that the code behind the software is open and transparent, allowing users to study, modify, improve, and customize the software according to their needs. Open-source software promotes collaboration, innovation, and community-driven development. Open-source software is often developed and maintained by a community of volunteers or organizations that share a common goal of creating high-quality software.

Open-source software is available on various platforms, such as: GitHub (github.com/), GitLab (gitlab.com/), SourceForge (sourceforge.net/), Apache Software Foundation (apache.org/); and GNU Project (www.gnu.org/).

Open-source software commonly, if not universally, is accompanied by documentation either in the code itself (i.e., comments), metadata, or corresponding data records in a documentation database. The documentation may include information identifying version numbers, dependencies, errors, vulnerabilities, or other defects. Accordingly, this documentation may reference, or be referenced by, standardized vulnerability databases including, but not limited to, National Vulnerability Database (NVD), CVE Details, and VulnDB. Each of these databases employ the use of Common Vulnerabilities and Exposures (CVE) and Common Weakness Enumeration (CWE including, but not limited to, Common Vulnerabilities and Exposure (CVE) and Common Weakness Enumeration (CWE).

Common Vulnerabilities and Exposures (CVE) is a dictionary or catalog of known cybersecurity vulnerabilities and exposures. CVE provides a standardized naming scheme and identification system for publicly disclosed vulnerabilities in software and hardware systems.

The purpose of CVE is to facilitate the sharing and exchange of information about vulnerabilities among security professionals, researchers, vendors, and end-users. CVE helps in establishing a common language and understanding when discussing security vulnerabilities and aids in their management and mitigation. CVE maintains:

Unique Identifiers: Each known vulnerability or exposure is assigned a unique CVE Identifier in the format “CVE-YYYY-NNNN.” The year (YYYY) indicates the year the identifier was assigned, and the number (NNNN) is a sequential identifier within that year.

Vulnerability Description: For each CVE Identifier, a detailed description of the vulnerability or exposure is provided, including information about the vulnerability's impact, affected systems, potential attack vectors, and any available mitigations or fixes.

Collaborative Effort: CVE is a collaborative effort involving multiple stakeholders, including cybersecurity researchers, vulnerability databases, product vendors, and security organizations. The coordination is managed by the MITRE Corporation, which maintains the CVE dictionary.

Integration with Security Tools: CVE Identifiers are widely used and referenced in various security tools, vulnerability scanners, and databases. This allows users to identify and track vulnerabilities across different systems and software.

Vulnerability Management: CVE helps organizations in vulnerability management by providing a standardized reference for known vulnerabilities. It enables security teams to assess their systems for the presence of specific vulnerabilities and prioritize their remediation efforts accordingly.

Mitigations and Fixes: CVE entries often include information about available mitigations or fixes, such as software patches, workarounds, or best practices to minimize the risk associated with a particular vulnerability.

Common Weakness Enumeration (CWE) is a community-developed list or taxonomy that catalogues common software and hardware security weaknesses. CWE provides a standardized language and framework for identifying, categorizing, and describing common programming and design flaws that can lead to security vulnerabilities.

The goal of CWE is to improve the understanding and awareness of software security weaknesses and to support the development of more secure software. CWE serves as a resource for software developers, security professionals, and researchers to better identify and address vulnerabilities during the software development lifecycle.

Key aspects of CWE include:

Weakness Identification: CWE identifies and names specific software weaknesses or flaws that can introduce security vulnerabilities. Each weakness is assigned a unique CWE Identifier in the format “CWE-NNN.”

Taxonomy and Categories: CWE organizes weaknesses into a hierarchical taxonomy, grouping them into different categories and subcategories based on their nature, root cause, and potential impact. This hierarchical structure helps in understanding the relationships and dependencies between different weaknesses.

Detailed Descriptions: Each CWE entry includes a detailed description of the weakness, providing information about its nature, typical symptoms, potential consequences, and guidance on how to detect and mitigate it. These descriptions aid in understanding the weakness and implementing effective countermeasures.

Relationships and Mapping: CWE establishes relationships and mappings with other related taxonomies, standards and frameworks, such as Common Vulnerabilities and Exposures (CVE), Common Attack Pattern Enumeration and Classification (CAPEC), and others. This helps in connecting weaknesses to specific vulnerabilities and attack patterns.

Common Language: CWE provides a common language and vocabulary to discuss software weaknesses and vulnerabilities. It helps bridge the communication gap between developers, security professionals, and researchers, enabling better collaboration and understanding of security-related issues.

Integration with Tools and Practices: CWE is supported by or integrated into various software security tools, static analysis tools, vulnerability scanners, and coding standards. It assists in identifying and remediating weaknesses during code analysis, code review, and secure coding practices.

Identifying vulnerabilities in software applications is a common task. To make sure the security posture of the software improves, it is vital that the software developers and security experts accurately fix the security flaws and do so in a timely manner. This often requires significant manual labor from highly skilled personnel in both software development and software application security, as well as computing resources to track, build, and test fixes. At enterprise scale, this becomes a resource-intensive endeavor.

### SUMMARY

Identifying vulnerabilities at scale for enterprise companies is a very common task for the security team in an organization. To make sure the security posture of their software improves, it is vital that the software developers and security experts fix the security flaws in an accurate and timely manner. In the prior art, this requires manual labor and a lot of expertise in both software development and software application security. At enterprise scale, this becomes an expensive endeavor as it may require significant time from expensive resources.

These and other needs are addressed by the various embodiments and configurations of the present invention. The present invention can provide a number of advantages depending on the particular configuration. These and other advantages will be apparent from the disclosure of the invention(s) contained herein.

In one embodiment, machine learning is provided to generate fixes and automate the process of generating training data for a model. As a result, the capabilities of an organization to automatically fix flaws in their codebase, reducing the risk of security related incidents, and unlocking higher efficiency in their software teams.

Embodiments herein are generally directed to systems and methods for automatically identifying known security flaws in software applications, selecting fixes to the identified security flaws, and deploying the selected fixes. The flaws may be fixed automatically without human input or, in another embodiment, obtaining human input merely as a trigger to conduct the automatic fix. In other embodiments, a qualified subset of fixes is determined from all potential fixes for selection of one of the subset of fixes and presented for selection and, upon receiving a selection input, implementing the selected fix. The qualified subset of fixes may be selected from the set of all fixes to a flaw having a probability of success that is over a previously determined threshold, which may be further limited to no more than a previously determined number of fixes. The systems and methods described herein may support the efforts of engineers to quickly and accurately fix flaws in software or automating the process without requiring any human intervention.

In one embodiment, machine learning is used to generate fixes and automate the process of generating training data for the model. As a result, the capabilities of an organization to fix flaws in their codebase is greatly improved and thereby reduces the risk of security related incidents as well as allowing resources to be allocated to other tasks.

Embodiments include several machine learning (ML) models. In one embodiment, a patch generation model is provided comprising an ML based system to generate patches directed to address code quality (e.g., efficiency, clarity, usability, reusability, etc.), security, and malware flaws. The ML based system comprises a patch generation model that is a pre-trained code generation model that has been trained with transfer learning to fix these knows flaws.

In another embodiment, the dataset used to train the patch generation model is automatically generated using static analysis and machine learning from a set of pre-and post-fixes of security vulnerabilities, malware, and/or quality issues. The dataset may be derived from public and/or proprietary code and their respective impacted version ranges. Static analysis is used to traverse the version ranges of the last impacted versions and first fixed version to identify the set of updates that encompasses the patch for the flaw.

In another embodiment, a patch identification model is provided wherein the ML model is used to classify each commit (e.g., fix or patch applied to the open-source software to address a security, malware, or quality issue) that was encompassed between the last impacted version (i.e., having the flaw still present in the code) and first fixed version of the software. The classification is performed by the ML on the commit-text (i.e., the fix for the flaw), metadata on the change such as number of lines changed, number of files changed, the files changed, programming language(s), the flaw type, additions and deletions, related code comments, as well as the code differences between each patch. The patch identification model produces a ranked list of the potential updates, and therefore increases the quality of the dataset. It is common behavior to release new versions of open-source and proprietary software that includes fixes to flaws as well as additional updates to prune the dataset. Furthermore, each vulnerability corresponds with or comprises a label for a Common Vulnerabilities and Exposure (CVE) entry associated with the patch that contains one or more Common Weakness Enumeration (CWE) and further indicates the type(s) of flaw(s) being addressed by the patch. Using ML, the training data is further improved by fixing any incorrectly labelled CWE's to correctly associate the flaw with the correct type so that accuracy of the ML model can improve over time.

In another embodiment, integration with Static Application Security Testing (SAST) is then performed such as to improve accuracy for a subset of vulnerabilities, SAST can also identify the flaw at the code level for the pre-patched version of the code and be used in such cases to verify that the post-patch version is no longer vulnerable. This can be a source of information for confirming the correct sections of the code for the relevant patch, as well as providing further insight regarding the type of underlying weakness (e.g., CWE identifier).

This dataset is used to train the patch generation ML model in different configurations, where configurations can encompass flaw types, such as CWE-ID, programming language, or training on proprietary code-fixes for a specific customer.

For the sake of simplicity, the term “vulnerability” and forms thereof includes any type of software/firmware vulnerability comprising a flaw, defect, or weakness in a software system that can be exploited by an attacker to compromise the security or functionality of the system. A defect may be a new defect (e.g., not previously known by an entity) or a known Common Vulnerabilities and Exposures (CVE). Defects may be intentional or unintentional. A defect that is intentionally inserted into the code of a software application is considered to be malware, a virus, an insider threat, and the like. A defect that is unintentionally inserted into the code of a software application is considered a weakness and the like. Weaknesses that can be exploited in a given context are considered vulnerabilities and are often represented by a CVE identifier once a patch is available and publicly known. Certain embodiments herein are directed to mitigation of both intentional and unintentional defects. Vulnerabilities are unintentional and/or undesirable aspects of software that may allow unauthorized access, data breaches, or other malicious activities. These flaws can exist in various components of the software, such as the code, design, or configuration of software portions. These vulnerabilities can result from programming errors, improper input validation, insecure coding practices, or outdated and unpatched software libraries. The term “vulnerability” (and forms thereof) excludes the intentional functionality and characteristics of a software component. In an alternative embodiment, “vulnerability” refers to identified vulnerabilities in a vulnerability repository (e.g., CVE database or other proprietary vulnerability database for in-house and/or externally developed software, etc.). Optionally, identifying and fixing software to address a vulnerability may additionally or alternatively include features or functionality, such as to add, remove, or modify a feature or functionality.

In some aspects, the techniques described herein relate to a computer-implemented method, including: identifying a weakness in a software component included by a software application, wherein the software component included by the software application is one version of a plurality of versions of the software component, and wherein each version of the plurality of versions of the software component has a corresponding release date; identifying a first set of versions of the software component that includes the weakness, the first set of versions of the software component including the version of the software component included by the software application; determining a code difference between (a) an earliest release date of a second set of versions of the software component that is absent the weakness and (b) a latest release date of the first set of versions of the software component that includes the weakness; generating a fix from the code difference; selecting a target software component having a similar weakness; and patching the target software component with the fix.

In some aspects, the techniques described herein relate to a computer-implemented method, wherein the fix includes a plurality of fixes, each fix of the plurality of fixes includes one or more of a code addition, code deletion, code reordering, or code alteration.

In some aspects, the techniques described herein relate to a computer-implemented method, wherein: identifying the weakness includes accessing a weakness database and obtaining therefrom a set of weakness and a corresponding set of weak software components; and identifying the software component included by the software application including matching entries in a build-list used to build the software application to the corresponding set of weak software components.

In some aspects, the techniques described herein relate to a computer-implemented method, wherein determining the code difference between the earliest release date of the second set of versions of the software component included by the software application and the latest release date of the first set of versions of the software component included by the software application further includes determining the code difference between a plurality of the second set of versions of the software component included by the software application and the first set of versions of the software component included by the software application.

In some aspects, the techniques described herein relate to a computer-implemented method, wherein: determining the code difference between the plurality of the second set of versions of the software component included by the software application and the first set of versions of the software component included by the software application includes determining a plurality of code differences between the plurality of the second set of versions of the software component included by the software application and the first set of versions of the software component included by the software application.

In some aspects, the techniques described herein relate to a computer-implemented method, wherein: determining the code difference between the earliest release date of the second set of versions of the software component included by the software application and the latest release date of the first set of versions of the software component included by the software application includes determining a plurality of code differences between the earliest release date of the second set of versions of the software component included by the software application and the latest release date of the first set of versions of the software component included by the software application.

In some aspects, the techniques described herein relate to a computer-implemented method, further including: analyzing each of the plurality of code differences to determine a probability of resolving the weakness; and wherein generating the fix from the code difference includes generating the fix utilizing the one of the plurality of code differences having the highest probability of resolving the weakness.

In some aspects, the techniques described herein relate to a computer-implemented method, wherein identifying the first set of versions of the software component included by the software application that include the weakness further includes: analyzing a superset of versions of the software component included by the software application, including at least the first set of versions of the software component included by the software application further including performing static application security testing (SAST) on each version of the superset of versions of the software component included by the software application and obtaining a weakness presence indicator from the SAST.

In some aspects, the techniques described herein relate to a computer-implemented method, wherein identifying the second set of versions of the software component included by the software application that are absent the weakness further includes analyzing a superset of versions of the software component included by the software application, including at least the second set of versions of the software component included by the software application, includes performing static application security testing (SAST) on each version of the superset of versions of the software component included by the software application and obtaining a weakness presence indicator from the SAST.

In some aspects, the techniques described herein relate to a computer-implemented method, further including: upon generating the fix from the code difference, performing static application security testing (SAST) and obtaining a weakness resolution indicator from the SAST; and upon the weakness resolution indicator being above a previously determined threshold, patching the software component with the fix.

In some aspects, the techniques described herein relate to a computer-implemented method, wherein identifying the first set of versions of the software component included by the software application that include the weakness includes identifying a comment associated therewith and indicating the weakness is present.

In some aspects, the techniques described herein relate to a computer-implemented method, wherein identifying the second set of versions of the software component included by the software application that are absent the weakness includes identifying a comment associated therewith and indicating the weakness is absent.

In some aspects, the techniques described herein relate to a system, including: a processor coupled to a computer memory, the computer memory including machine-executable instructions to cause the processor to perform: identifying a weakness in a software component included by a software application, wherein the software component included by the software application is one version of a plurality of versions of the software component, and wherein each version of the plurality of versions of the software component has a corresponding release date; identifying a first set of versions of the software component that includes the weakness, the first set of versions of the software component including the version of the software component included by the software application; determining a code difference between (a) an earliest release date of a second set of versions of the software component that is absent the weakness and (b) a latest release date of the first set of versions of the software component that includes the weakness; generating a fix from the code difference; selecting a target software component having a similar weakness; and patching the target software component with the fix.

In some aspects, the techniques described herein relate to a system, wherein the instructions further cause the processor to perform: identifying the weakness including accessing a weakness database and obtaining therefrom a set of weakness and a corresponding set of weak software components; and identifying the software component included by the software application including matching entries in a build-list used to build the software application to the corresponding set of weak software components.

In some aspects, the techniques described herein relate to a system, wherein the instructions to cause the processor to perform determining the code difference between the earliest release date of the second set of versions of the software component included by the software application and the latest release date of the first set of versions of the software component included by the software application further include instructions to cause the processor to perform determining the code difference between a plurality of the second set of versions of the software component included by the software application and the first set of versions of the software component included by the software application.

In some aspects, the techniques described herein relate to a system, wherein determining the code difference between the plurality of the second set of versions of the software component included by the software application and the first set of versions of the software component included by the software application includes determining a plurality of code differences between the plurality of the second set of versions of the software component included by the software application and the first set of versions of the software component included by the software application.

In some aspects, the techniques described herein relate to a system, wherein determining the code difference between the earliest release date of the second set of versions of the software component included by the software application and the latest release date of the first set of versions of the software component included by the software application includes determining a plurality of code differences between the earliest release date of the second set of versions of the software component included by the software application and the latest release date of the first set of versions of the software component included by the software application.

In some aspects, the techniques described herein relate to a system, further including instructions to cause the processor to perform: analyzing each of the plurality of code differences to determine a probability of resolving the weakness; and wherein generating the fix from the code difference includes generating the fix utilizing the one of the plurality of code differences having the highest probability of resolving the weakness.

In some aspects, the techniques described herein relate to a system, wherein the instructions to cause the processor to perform identifying the second set of versions of the software component included by the software application that are absent the weakness further include analyzing a superset of versions of the software component included by the software application, including at least the second set of versions of the software component included by the software application, further include the instructions to cause the processor to perform static application security testing (SAST) on each version of the superset of versions of the software component included by the software application and obtaining a weakness presence indicator from the SAST.

In some aspects, the techniques described herein relate to a non-transient computer readable medium containing program instructions for causing a computer to perform a method of: identifying a weakness in a software component included by a software application, wherein the software component included by the software application is one version of a plurality of versions of the software component, and wherein each version of the plurality of versions of the software component has a corresponding release date; identifying a first set of versions of the software component that includes the weakness, the first set of versions of the software component including the version of the software component included by the software application; determining a code difference between (a) an earliest release date of a second set of versions of the software component that is absent the weakness and (b) a latest release date of the first set of versions of the software component that includes the weakness; generating a fix from the code difference; selecting a target software component having a similar weakness; and patching the target software component with the fix.

Aspects may include a system on a chip (SoC) including any one or more of the above aspects or aspects of the embodiments described herein.

One or more means for performing any one or more of the above aspects or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112 (f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a software component in accordance with embodiments of the present disclosure;

FIG. 2 depicts a process flow in accordance with embodiments of the present disclosure;

FIG. 3 depicts a process flow in accordance with embodiments of the present disclosure;

FIG. 4 depicts a process in accordance with embodiments of the present disclosure;

FIG. 5 depicts an example source code with a vulnerability;

FIG. 6 depicts an example source code with a vulnerability patched; and

FIG. 7 depicts a device in a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

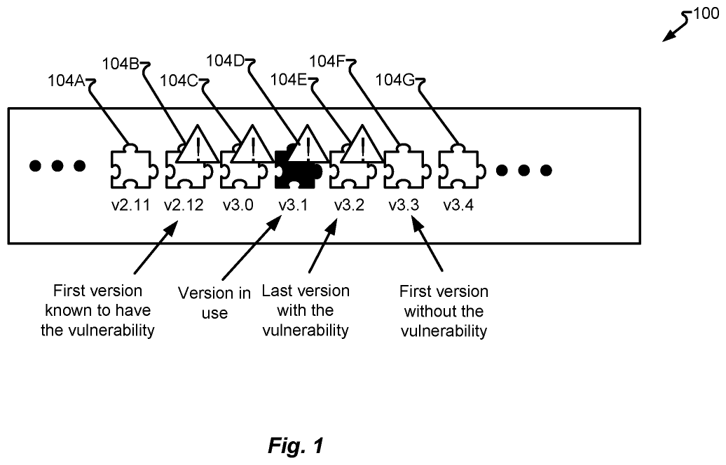

FIG. 1 depicts software component 100 in accordance with embodiments of the present disclosure. Software applications comprise at least one, and often many, software components such as software component 100, which may be an open-source component (e.g., open-source software) providing features or functionality to the software application. The open-source components commonly change over time. A vulnerability may be introduced in the original version of software component 100 or any subsequent version of the open-source component. Vulnerabilities may be subsequently discovered. As a result, software component 100 (or a particular version or subset of versions) may have been thought to be absent a particular vulnerability (or no such vulnerability was known at the time) but once the vulnerability is discovered, one or more versions of software component 100 may be vulnerable to the particular vulnerability. One of ordinary skill in the art will appreciate that the embodiments herein, while primarily directed towards open-source software (e.g., open-source components), may be applied to proprietary or other software without departing from the scope of the embodiments herein. For example, an enterprise may have a catalog of software components, whether developed in-house, purchased, acquired elsewhere, and/or modifications thereto, that may or may not be available to others (e.g., not “open-source”) but otherwise are accessible to the enterprise for development and maintenance of the enterprise's software applications and portions thereof. The software components may be embodied as a complete executable software application or a portion of an application, whether called or called by another portion. The portion may be a portion of a software build (e.g., dynamic link library, application programming interface, object module, etc.) or a logical or functional portion (e.g., code to sort items in a list, a company standardized back-end for presenting and processing a graphical element, etc.).

In one embodiment, a software application comprises one version of software component 100. It should be appreciated that the same or different software component may comprise additional instances of software component 100, which may be the same and/or different version. As a result software component 100 may have multiple vulnerabilities and/or comprise vulnerable and non-vulnerable versions of the same software component 100.

In one embodiment, software component 100 comprises versions 104A-104G. Differences between any consecutive versions 104A-104G may be to add, remove, or alter a feature or function. Although less common, differences between consecutive versions 104A-104G may not affect the operation of the version or software component 100, such as updates to documentation or re-numbering a version. While a particular vulnerability is discussed as being present at a first second time (e.g., first version or subsequently introduced after the first version) and being absent at a second later time, vulnerabilities may be re-introduced (e.g., present in two different subsets of versions separated by at least one version without the vulnerability). Accordingly, and in one embodiment, the at least one version without the vulnerability may be ignored (e.g., considered to be not vulnerable) and the fix determined based on the difference between the last vulnerable version and the immediately following non-vulnerable version.

However, in another embodiment, each set of versions that have at least one vulnerable version immediately followed by a version without the vulnerability may be considered separately (e.g., the “fix” determined multiple times). The application of the fix wherein the source code of a software application is modified to overcome the vulnerability is generally referred to as “patching” the source code. In another embodiment, patching may not require the source code of software component 100 to be altered. For example, patching may comprise changing a resource (e.g., file, link library, include library, etc.) utilized by software component 100 file from one version of the resource, having the vulnerability, to a different version of the resource, absent the vulnerability.

As will become apparent with respect to the embodiments that follow, software component 100 comprises at least three versions. One version is the earliest (i.e., oldest) version where a vulnerability is identified, a first subsequent (i.e., newer) version that is the last version having the vulnerability, and a second subsequent (i.e., newest) version that is the first version where the vulnerability, once present, is now absent. For example, the software application may utilize open-source component version v3.1 (104D) having a vulnerability (designated by the exclamation mark inside a triangle). The vulnerability is first known to exist in open-source component v2.12 (104B) is possible that the vulnerability existed in earlier versions. The vulnerability is known to exist in open-source component versions v2.12-v3.2 (104B-104E).

Open-source component versions v3.3 (104F) is known to be absent the vulnerability. Additional versions, such as subsequent open-source component version v3.4 (104G) may also be absent the vulnerability. While merely updating the software application to include the latest version (or other non-vulnerable version) may remove the vulnerability, functional dependencies may make such an approach undesirable or inoperable. For example, the latest version open-source component versions may introduce a different operation or dependency on another (unwanted or unusable) component etc. that would require additional effort to detect and resolve. Additionally, open-source software may be used in a software application in part, rather than including all the code for a particular software component 100. As a result, merely updating the version may include unnecessary or unwanted features. As will be discussed more completely with respect to the embodiments that follow, knowing how a vulnerability was fixed allows for the automatic application of the fix to other software.

In another embodiment, accurately detecting what code changed that occurred between a last version with a vulnerability and the first subsequent version without the vulnerability (e.g., code deltas) allows the application of the deltas to other software. Open-source component version changes may resolve a detected vulnerability but may also incorporate other changes, such as to add, remove or alter one or more features or functionality of the software component 100. Accordingly, identifying the resolution to a particular vulnerability includes, but is not limited to, determining the differences between the source code of one version (with a vulnerability) to a subsequent version (with the vulnerability resolved).

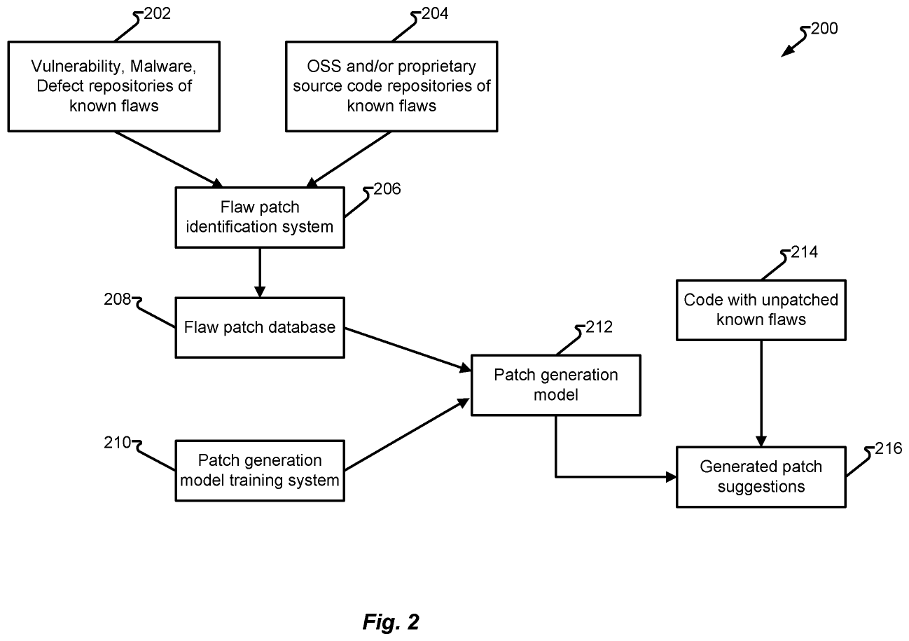

FIG. 2 depicts process flow 200 in accordance with embodiments of the present disclosure. In one embodiment, a first combination formed by steps 202, 204, 206, 208, and 210 may operate independently of a second combination formed by steps 212, 214, and 216 once at least one execution of the first combination has been performed. In other embodiments, the execution of the first combination and the second combination may be coordinated. In one embodiment, a system is provided comprising at least one processor coupled to a computer memory, and the computer memory comprises instructions to cause the at least one processor to perform the steps of process flow 200. In another embodiment, one or more of the at least one processor comprises, or is coupled with, a communication interface, such as to exchange data with another processor/server, data storage, network, and/or user input-output device.

Step 202 accesses one or more repositories of vulnerabilities. Example repositories for large collections of vulnerabilities, malware, and flaws include the National Vulnerability Database (NVD), GitHub Advisory, and proprietary databases containing weaknesses detected by a security tool and/or other means. The volume of data may be vast and is estimated to include 30K-50K vulnerabilities that have presently been reported to the NVD database for open-source projects, with vulnerabilities continually increasing year-over-year, and an estimated 8K-10K being disclosed annually.

Step 204 accesses one or more repositories of source code repositories of known flaws, such as open-source software (OSS) and/or proprietary source code repositories. Source code with known flaws will ultimately be stored in source code repositories. The source code in such repositories will contain commits or pull requests that were responsible for fixing identified flaws that are associated with either a Common Vulnerabilities and Exposure (CVE) identifier or other metadata related to how the vulnerability, malware, or flaw was detected or reported (e.g., source code review, automated vulnerability scanner, etc.). Data will contain not only the project source code, but also the different versions of the source code, metadata information, and pull/merge requests and their associated change histories. For each disclosed vulnerability (e.g., CVE entry), the disclosure is for a particular project and range of impacted versions. As one estimation, if 50K flaws exist in a single vulnerability repository, with an average of ten impacted versions, then there are 500K unique code versions in the source code repository under analysis. Each project may consist of a reusable component (e.g., Apache Log4J) or an entire software application (e.g., Apache HTTPD), where the project consists of many source files with large amounts of executable lines of code (ELOC).

In another embodiment, step 204 identifies source code with a vulnerability via automated system accessing documentation, whether internal or external. For example, one source code file may identify the name of an included second source code file name which matches an entry in the known vulnerability repositories. Additionally or alternatively, software may comprise a built list that identifies the included source code file matching the known vulnerabilities. A machine-learning function may automatically perform the cataloging of the included source code files to determine a match to those having known vulnerabilities (e.g., step 202). Additionally or alternatively, the machine-learning function may pattern-match the source code with the pattern of the vulnerable source code, such as when the text of vulnerable source code is copied for subsequent use into other source code, as-is or with minor modifications (i.e., altered in a way that does not affect the vulnerability).

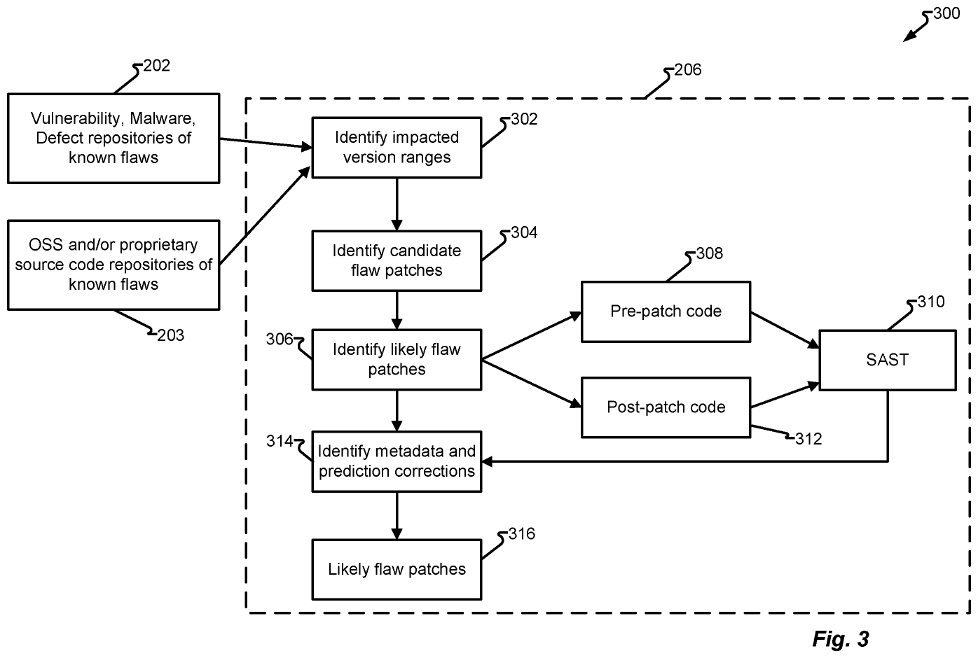

Step 206 executes a flaw patch identification system or process to precisely identify the patches required to address a vulnerability, malware, or other flaw. The patches are determined and extracted from one or more version ranges in a repository (e.g., git repository). Step 206 is described in more detail with respect to process flow 300 (see FIG. 3).

Step 208 accesses a flaw patch database. The flaw patch database contains the automatically generated dataset of pre-and post-fixes for each flaw determined in step 206. Additional metadata may be stored with each vulnerability, malware, or flaw types (e.g., CWE-ID, programming language, additional code-context, size of fix, size of flaw, and source metadata).

Step 210 trains the patch generation training machine-learning model. Step 210 utilizes the flaw patch database (see step 208) to train or fine-tune a machine learning model to generate security patches. Protocols are utilized to identify the regions of code that indicate the pre-fix code and the associate post-fix code. For example, one embodiment of the protocol for each entry in the flaw database and generation target is as follows:

<FLAW_TYPE>
....<S2SV_StartBug>[Code containing the flaw]<S2SV_EndBug>

And the generated patch has the following protocol:

<S2SV_ModStart>[Code that fixes the flaw]<S2SV_ModEnd>
Where:
∘ <FLAW_TYPE>: The type of the flaw, for instance CWE-287
∘ <S2SV_StartBug>: Start of flaw
∘ <S2SV_EndBug>: End of flaw
∘ <S2SV_ModStart>: Start of fix
∘ <S2SV_ModEnd>: End of fix

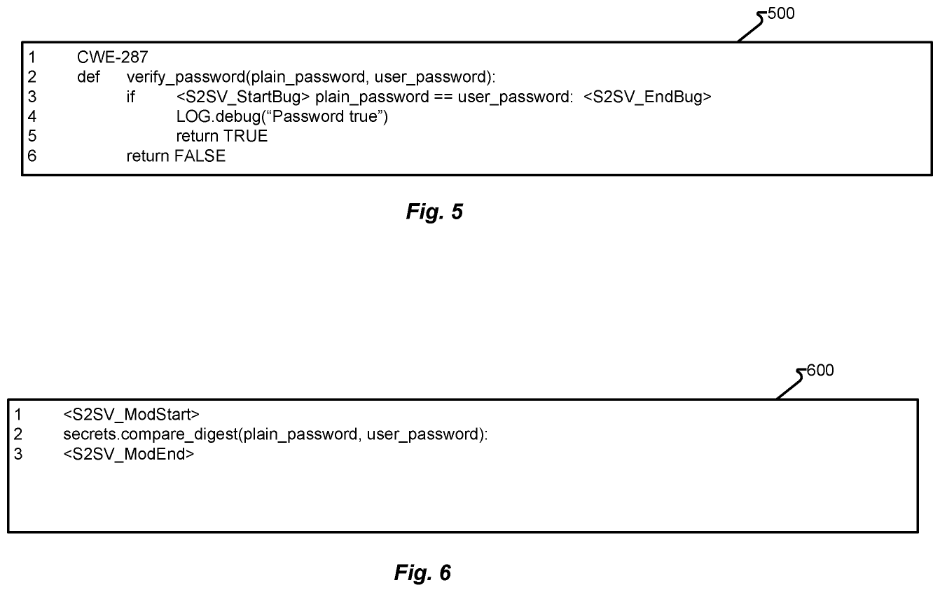

See example source code 500 (FIG. 5) for source code having the flaw. See example source code 600 (FIG. 6) for the source code with the flaw patched.

The training system may train a general model based on non-sensitive data (such as open-source vulnerabilities), or specialized models for a particular set of flaw types, programming language, or for a specific codebase. In another embodiment, the training system is specifically trained on a set of proprietary codebases by either finetuning the existing base model or creating a completely new model. The case for finetuning occurs when a code base shares many commonalities with the base model, however, the code base also contains proprietary code that extends the model. The case for creating a new model may occur when the proprietary code base contains the same pre-patch code patterns but prioritized a different set of remediation patches than those of the base model.

Step 212 refines the patch generation model. The trained model is stored and made available for inference (step 208). The resulting trained model then determines the context of unfixed flaws in a codebase and generates one or more potential fixes to address the flaw. The context of the unfixed flaw matches the data the model was trained on, such as flaw type, etc. The generation of a fix (e.g., one or more of steps 210, 212, and 216) is variously embodied with the trained machine learning model selecting the appropriate fix to address a particular vulnerability in a particular software component. For example, and in one embodiment, the generation of a fix may be a cut-and-paste of source code text to replace a vulnerability with similar functionality absent the vulnerability. In another embodiments, the vulnerability is fixed with similar functionality tailored to a particular software component. For example, a machine-learning module may determine a code-injection vulnerability is present in a database application and in a client-side application used to collect user information. As a result of the underlying code having the vulnerability being dissimilar, the machine-learning module may customize the fix for each component or application type in order to resolve the vulnerability while maintaining the existing functionality. As a further embodiment, if the software fails, such as due to the fix introducing a compile or link error or new erroneous operation, the machine-learning module is provided with the failure in a subsequent (or continuous) training step. The feedback is provided to cause the machine-learning module to exclude or down-weight the selection of similar fixes and/or the application of similar fixes to similar software components in the future. Conversely, if the post-fix software application functions as intended, and the vulnerability is resolved without causing new failures or vulnerabilities, such feedback may similarly be provided to the machine-learning module. The feedback is provided to cause the machine-learning module to include or up-weight the selection of similar fixes and/or the application of similar fixes to similar software components in the future.

The machine-learning module once trained (and optionally subsequently or continually trained) to fix a vulnerability, may apply the fix to a target software component. The target software component may be a vulnerable software component used to train the machine-learning module or a different software component. The target software component may have an identical vulnerability (e.g., character-by-character pattern of source code that matches the vulnerability) or be similar (e.g., the same type of vulnerability is present but embodied in non-identical source code). The similarities may further be determined by the same or different machine learning module trained to identify the vulnerability that may or may be similar and not be an exact match. The machine learning module may determine that target software component comprises a similar version of the vulnerability and apply the fix as described herein. If the fix is inappropriate (e.g., the target software application did not have the vulnerability or a non-identical but similar vulnerability) the target software application may fail (e.g., fails to compile, the vulnerability remains, new erroneous operations, etc.), the machine-learning model may be provided with such a failure as feedback. The feedback is provided to cause the machine-learning module to exclude or down-weight the identification of similar software applications as a target software applications having a similar vulnerability. Conversely, if the fix is appropriate (e.g., the target software application had the vulnerability or a non-identical but similar vulnerability) the target software application operates as intended and without the vulnerability, the machine-learning model may be provided with such a success as a feedback. The feedback is provided to cause the machine-learning module to include or up-weight the identification of similar software applications as a target software applications having a similar vulnerability.

Step 214 accesses the code with unpatched known flaws. The code with the unpatched known flaws may be a portion of a codebase of known flaws, such as a proprietary codebase that has been scanned with a security product (e.g., with SAST tools specifically designed to identify security vulnerabilities, malware, or other flaws). It is known what type of flaws exist, and exactly where in the codebase the flaws are located.

Step 216 generates the patches. The machine-learning model performs inference on the known flaws without patches from step 214 to identify which code patterns from the patch generation model correlate with each specific context for each vulnerability, malware, or flaw that has been identified in the code in step 214. The patches could be a set of N most likely patches, or simply the most likely patch depending upon policy configuration settings for the consumer of the system. For example, if a consumer desired to set a probabilistic threshold that indicates how strongly a particular patch matches a particular context, then they can choose to only provide that single patch suggestion. Alternatively, a consumer could set a minimum threshold which would then provide a set of patch suggestions which all meet or exceed the specified threshold.

Step 216 may be fully automated, such as when the probability of an identified patch to address a vulnerability is above a previously determined threshold, and the patch may be automatically applied without requiring human intervention. In another embodiment, a ranked list of patches may be provided and, upon receiving a selection from a user, the corresponding patch is applied without further human intervention.

In one example utilizing certain embodiments herein, a consumer uses a SAST tool to identify vulnerability flaws in a target application or component. As part of the resulting set of identified flaws are several instances where the code under analysis contains the use of identified Weak Cryptographic Hashes. In one embodiment the Weak Cryptographic Hash in use is SHA1. In another embodiment, the Weak Cryptographic Hash in use is DES. In both instances, the generated patch suggestions may be to use SHA256. However, SHA256 is not the only alternative that is considered more secure than the vulnerable alternatives. The generated patch suggestions can be configured to produce more than one recommended patch. In another embodiment, the recommended patch may require some context-specific recommendations from the developer responsible for patching the newly detected flaw (214). As such, the patch generation model (212) may recommend a patch which is only partially complete. Specifically, the proposed patch identifies portions of the code which must be completed by the developer prior to completing the fix. Under such an embodiment, the proposed fix is deemed a patch template that requires customization by the developer. Such a workflow can only be partially automated due to the requirement of the developer providing context-specific business logic

Following the innovations above, the consumer will receive one or more suggestions on how to remediate their code though the selection of the provided patch proposal. Accompanying each of the proposed fixes is an associated Learning Instance chatbot which will allow the consumer to ask questions about the proposed fixes within the context. For example, a consumer could ask questions such as “is DES considered insecure?”, “is SHA1 considered insecure?”, “is SHA256 considered more secure than SHA1?”, and so on. In one embodiment of a context-specific chatbot, the set of questions can be limited to those that are semantically relevant to the patch and sufficiently deterministic as to the expected response (its correctness).

FIG. 3 depicts process flow 300 in accordance with embodiments of the present disclosure. Process flow 300 comprises a more detailed embodiment of step 206 (see FIG. 2). Steps 202 and 203 (see FIG. 2) provide vulnerability and target source code, respectively, to step 302. In one embodiment, a system is provided comprising at least one processor coupled to a computer memory, the computer memory comprises instructions to cause the at least one processor to perform the steps of process flow 300. In another embodiment, one or more of the at least one processor comprises, or is coupled with, a communication interface, such as to exchange data with another processor/server, data storage, network, and/or user input-output device.

In one embodiment, step 302 identifies impacted version ranges (e.g., versions comprising a vulnerability or other flaw). to identify version ranges that were impacted and not impacted for a particular flaw. For vulnerabilities with associated CVEs, the set of impacted versions for the component or application under analysis is provided. For other vulnerabilities, malware, or flaws the identification of impacted versions requires analysis of the source repository to determine when the pre-patch code was first introduced, and then infer from the set of metadata (e.g., the tags associated with the main branch) which versions contained the pre-patch code.

Step 304 identifies candidate flaw patches. Step 304 identifies all changes between the latest impacted version and first non-impacted version with static analysis. This generates a set of candidate flaw patches that has the actual flaw patch in the set, but it is not certain which change within the set of changes that is the actual flaw patch. For instance, when open-source project resolves security issues it is common that those patches are released as a part of a larger release with multiple other changes to the codebase. The version range associated with the CVE may not include the actual commit that is the fixing patch, which makes it unknown what part of the new release is the actual flaw patch. In another embodiment, step 304 incorporates, in whole or in part, the teachings of patent application Ser. No. 18/098,582 incorporated herein by reference.

Step 306 utilizes a machine-learning model to identify flaw patches. Here, the machine-learning model takes all commits, metadata for each commit (#files changed, #lines deleted, #lines added, etc.), and each code-diff associated with each commit, between the latest impacted version and first non-impacted version. This data is used by the Flaw Patch Identification System (see FIG. 2, step 206) to generate a prediction for each commit/code-diff pair to identify the most likely flaw patches. In another embodiment, step 306 incorporates, in whole or in part, the teachings of patent application Ser. No. 18/098,582 incorporated herein by reference.

Once the pre-and post-patch sections of code have been identified (step 306), the complete set of code under analysis (component or application) is retrieved as two variants. More specifically, step 308 accesses the first variant (or version) which consists of the first version of the code prior to the patch containing the vulnerability, malware, or flaw. Step 312 accesses the second variant (or version) comprising the patched version of the code immediately following the version identified in step 308. The result of steps 308 and 312 are provided to step 310 wherein SAST techniques capable of identifying the vulnerability, malware, or flaw in step 308 and verifying that the vulnerability, malware, or flaw is no longer detected in step 312. The results of the SAST analysis are then fed back into step 314 for verification and metadata corrective actions.

Step 314 identifies metadata corrections. A machine-learning model is trained and provided to correct metadata in the provided training data to improve the accuracy of the patch generation model. Repositories of vulnerabilities, malware, and defects ultimately contain incorrect metadata (e.g., CWE labels for CVEs in vulnerability databases). To further train the machine-learning model, and thereby improve accuracy over time, the patch generation model (see step 212, FIG. 2), attributes code patterns to their associated flaw types.

Step 316 extracts (likely) flaw patches for input into the flaw patch database (see, Step 208, FIG. 2) for future consideration as solutions when similar code patterns are detected in other code bases, such as automated evaluation by machine-learning models performing step 212 (see FIG. 2).

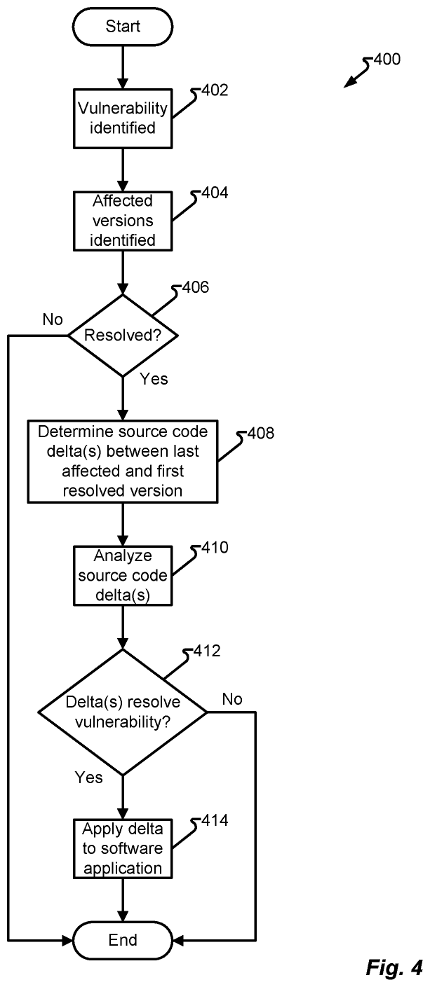

FIG. 4 depicts process 400 in accordance with embodiments of the present disclosure. In one embodiment, process 400 is embodied as machine-readable instructions maintained in a non-transitory memory that when read by a machine, such as a processor of a server, cause the machine to execute the instructions and thereby execute process 400.

In one embodiment, process 400 begins and step 402 identifies a vulnerability. Step 402 may comprise the automated evaluation of a software vulnerability repository. Step 404 identifies the affected versions of a software source code that comprise the vulnerability or other flaw. For example, versions v2.12-v3.2 (104B, 104C, 104D, 104E) of software component 100 (see FIG. 1).

Test 406 determines if the vulnerability has a version or variant that resolves the vulnerability. If test 406 is determined in the negative, process 400 may end, such as to trigger a manual resolution of the vulnerability. If test 406 is determined in the positive, processing continues to step 408 wherein the code deltas between the affected source code and resolved source code are determined. Step 410 further analyzes the source code (e.g., SAST) to determine if the affected source code does indeed comprise the vulnerability and similarly the resolved source code is absent the vulnerability. If both conditions are true, then test 412 is determined in the affirmative. If test 412 is determined in the negative, process 400 ends, such as to trigger manual resolution of the vulnerability. With the code deltas identified that will resolve the vulnerability, step 414 applies the patch to other source code comprising the vulnerability. FIG. 5 depicts example source code 500 with a vulnerability.

FIG. 6 depicts example source code 600 with a vulnerability patched. In one embodiment, example source code 600 illustrates source code 500 with the vulnerability after the vulnerability has been patched.

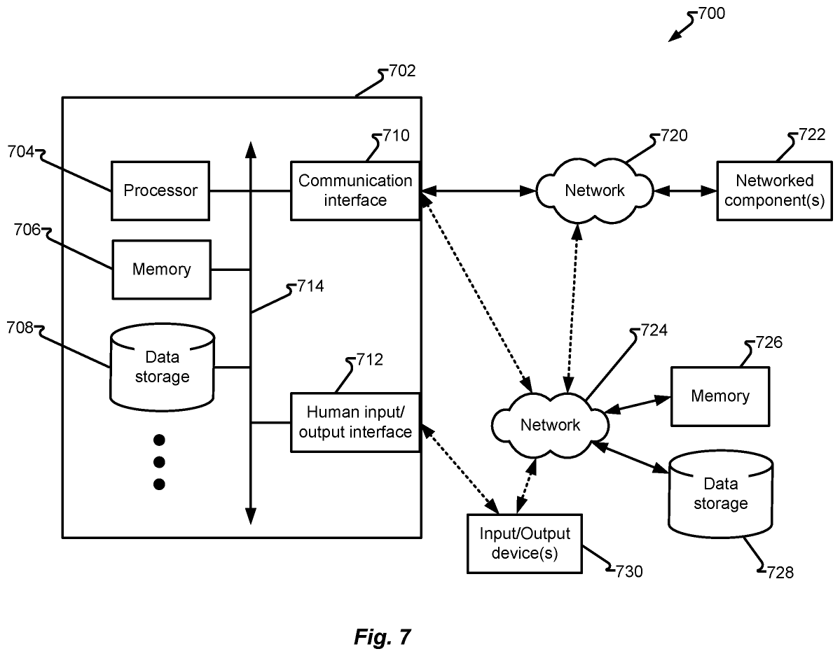

FIG. 7 depicts device 702 in system 700 in accordance with embodiments of the present disclosure. In one embodiment, device 702 comprising various components and connections to other components and/or systems. The components are variously embodied and may comprise processor 704. The term “processor,” as used herein, refers exclusively to electronic hardware components comprising electrical circuitry with connections (e.g., pin-outs) to convey encoded electrical signals to and from the electrical circuitry. Processor 704 may comprise programmable logic functionality, such as determined, at least in part, from accessing machine-readable instructions maintained in a non-transitory data storage, which may be embodied as circuitry, on-chip read-only memory, computer memory 706, data storage 708, etc., that cause the processor 704 to perform the steps of the instructions. Processor 704 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 714, executes instructions, and outputs data, again such as via bus 714. In other embodiments, processor 704 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 704 is a non-transitory computing device (e.g., electronic machine comprising circuitry and connections to communicate with other components and devices). Processor 704 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 704). Processor 704 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 704, device 702 may utilize computer memory 706 and/or data storage 708 for the storage of accessible data, such as instructions, values, etc. Network interface 710 facilitates communication with components, such as processor 704 via bus 714 with components not accessible via bus 714. Network interface 710 may be embodied as a network port, card, cable, or other configured hardware device. Additionally or alternatively, human input/output interface 712 connects to one or more interface components to receive and/or present information (e.g., instructions, data, values, etc.) to and/or from a human and/or electronic device. Examples of input/output devices 730 that may be connected to input/output interface include, but are not limited to, keyboard, mouse, trackball, printers, displays, sensor, switch, relay, speaker, microphone, still and/or video camera, etc. In another embodiment, network interface 710 may comprise, or be comprised by, human input/output interface 712. Network interface 710 may be configured to communicate directly with a networked component or configured to utilize one or more networks, such as network 720 and/or network 724.

Network 720 may be a wired network (e.g., Ethernet), wireless (e.g., WiFi, Bluetooth, cellular, etc.) network, or combination thereof and enable device 702 to communicate with networked component(s) 722. In other embodiments, network 720 may be embodied, in whole or in part, as a telephony network (e.g., public switched telephone network (PSTN), private branch exchange (PBX), cellular telephony network, etc.).

Additionally or alternatively, one or more other networks may be utilized. For example, network 724 may represent a second network, which may facilitate communication with components utilized by device 702. For example, network 724 may be an internal network to a business entity or other organization, whereby components are trusted (or at least more so) than networked components 722, which may be connected to network 720 comprising a public network (e.g., Internet) that may not be as trusted.

Components attached to network 724 may include computer memory 726, data storage 728, input/output device(s) 730, and/or other components that may be accessible to processor 704. For example, computer memory 726 and/or data storage 728 may supplement or supplant computer memory 706 and/or data storage 708 entirely or for a particular task or purpose. As another example, computer memory 726 and/or data storage 728 may be an external data repository (e.g., server farm, array, “cloud,” etc.) and enable device 702, and/or other devices, to access data thereon. Similarly, input/output device(s) 730 may be accessed by processor 704 via human input/output interface 712 and/or via network interface 710 either directly, via network 724, via network 720 alone (not shown), or via networks 724 and 720. Each of computer memory 706, data storage 708, computer memory 726, data storage 728 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 730 may be a router, a switch, a port, or other communication component such that a particular output of processor 704 enables (or disables) input/output device 730, which may be associated with network 720 and/or network 724, to allow (or disallow) communications between two or more nodes on network 720 and/or network 724. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits.

Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMS, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™M family of microprocessors, the Intel® Xeon® family of microprocessors, the Intel® Atom™M family of microprocessors, the Intel Itanium® family of microprocessors, Intel® Core® i5-4670K and i7-4770K 22 nm Haswell, Intel® Core i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A computer-implemented method, comprising:
identifying a weakness in a software component comprised by a software application, wherein the software component comprised by the software application is one version of a plurality of versions of the software component, and wherein each version of the plurality of versions of the software component has a corresponding release date;
identifying a first set of versions of the software component that comprises the weakness, the first set of versions of the software component comprising the version of the software component comprised by the software application;
determining a code difference between (a) an earliest release date of a second set of versions of the software component that is absent the weakness and (b) a latest release date of the first set of versions of the software component that comprises the weakness;
generating a fix from the code difference;
selecting a target software component having a similar weakness; and
patching the target software component with the fix.

2. The computer-implemented method of claim 1, wherein the fix comprises a plurality of fixes, each fix of the plurality of fixes comprises one or more of a code addition, code deletion, code reordering, or code alteration.

3. The computer-implemented method of claim 1, wherein:
identifying the weakness comprises accessing a weakness database and obtaining therefrom a set of weakness and a corresponding set of weak software components; and
identifying the software component comprised by the software application comprising matching entries in a build-list used to build the software application to the corresponding set of weak software components.

4. The computer-implemented method of claim 1, wherein determining the code difference between the earliest release date of the second set of versions of the software component comprised by the software application and the latest release date of the first set of versions of the software component comprised by the software application further comprises determining the code difference between a plurality of the second set of versions of the software component comprised by the software application and the first set of versions of the software component comprised by the software application.

5. The computer-implemented method of claim 4, wherein:
determining the code difference between the plurality of the second set of versions of the software component comprised by the software application and the first set of versions of the software component comprised by the software application comprises determining a plurality of code differences between the plurality of the second set of versions of the software component comprised by the software application and the first set of versions of the software component comprised by the software application.

6. The computer-implemented method of claim 1, wherein:
determining the code difference between the earliest release date of the second set of versions of the software component comprised by the software application and the latest release date of the first set of versions of the software component comprised by the software application comprises determining a plurality of code differences between the earliest release date of the second set of versions of the software component comprised by the software application and the latest release date of the first set of versions of the software component comprised by the software application.

7. The computer-implemented method of claim 6, further comprising:
analyzing each of the plurality of code differences to determine a probability of resolving the weakness; and
wherein generating the fix from the code difference comprises generating the fix utilizing the one of the plurality of code differences having the highest probability of resolving the weakness.

8. The computer-implemented method of claim 7, wherein identifying the first set of versions of the software component comprised by the software application that comprise the weakness further comprises:
analyzing a superset of versions of the software component comprised by the software application, comprising at least the first set of versions of the software component comprised by the software application further comprising performing static application security testing (SAST) on each version of the superset of versions of the software component comprised by the software application and obtaining a weakness presence indicator from the SAST.

9. The computer-implemented method of claim 1, wherein identifying the second set of versions of the software component comprised by the software application that are absent the weakness further comprises analyzing a superset of versions of the software component comprised by the software application, comprising at least the second set of versions of the software component comprised by the software application, comprises performing static application security testing (SAST) on each version of the superset of versions of the software component comprised by the software application and obtaining a weakness presence indicator from the SAST.

10. The computer-implemented method of claim 1, further comprising:
upon generating the fix from the code difference, performing static application security testing (SAST) and obtaining a weakness resolution indicator from the SAST; and
upon the weakness resolution indicator being above a previously determined threshold, patching the software component with the fix.

11. The computer-implemented method of claim 1, wherein identifying the first set of versions of the software component comprised by the software application that comprise the weakness comprises identifying a comment associated therewith and indicating the weakness is present.

12. The computer-implemented method of claim 1, wherein identifying the second set of versions of the software component comprised by the software application that are absent the weakness comprises identifying a comment associated therewith and indicating the weakness is absent.

13. A system, comprising:
a processor coupled to a computer memory, the computer memory comprising machine-executable instructions to cause the processor to perform:
identifying a weakness in a software component comprised by a software application, wherein the software component comprised by the software application is one version of a plurality of versions of the software component, and wherein each version of the plurality of versions of the software component has a corresponding release date;
identifying a first set of versions of the software component that comprises the weakness, the first set of versions of the software component comprising the version of the software component comprised by the software application;
determining a code difference between (a) an earliest release date of a second set of versions of the software component that is absent the weakness and (b) a latest release date of the first set of versions of the software component that comprises the weakness;
generating a fix from the code difference;
selecting a target software component having a similar weakness; and
patching the target software component with the fix.

14. The system of claim 13, wherein the instructions further cause the processor to perform:
identifying the weakness comprising accessing a weakness database and obtaining therefrom a set of weakness and a corresponding set of weak software components; and
identifying the software component comprised by the software application comprising matching entries in a build-list used to build the software application to the corresponding set of weak software components.

15. The system of claim 13, wherein the instructions to cause the processor to perform determining the code difference between the earliest release date of the second set of versions of the software component comprised by the software application and the latest release date of the first set of versions of the software component comprised by the software application further comprise instructions to cause the processor to perform determining the code difference between a plurality of the second set of versions of the software component comprised by the software application and the first set of versions of the software component comprised by the software application.

16. The system of claim 15, wherein determining the code difference between the plurality of the second set of versions of the software component comprised by the software application and the first set of versions of the software component comprised by the software application comprises determining a plurality of code differences between the plurality of the second set of versions of the software component comprised by the software application and the first set of versions of the software component comprised by the software application.

17. The system of claim 13, wherein determining the code difference between the earliest release date of the second set of versions of the software component comprised by the software application and the latest release date of the first set of versions of the software component comprised by the software application comprises determining a plurality of code differences between the earliest release date of the second set of versions of the software component comprised by the software application and the latest release date of the first set of versions of the software component comprised by the software application.

18. The system of claim 17, further comprising instructions to cause the processor to perform:
analyzing each of the plurality of code differences to determine a probability of resolving the weakness; and
wherein generating the fix from the code difference comprises generating the fix utilizing the one of the plurality of code differences having the highest probability of resolving the weakness.

19. The system of claim 13, wherein the instructions to cause the processor to perform identifying the second set of versions of the software component comprised by the software application that are absent the weakness further comprise analyzing a superset of versions of the software component comprised by the software application, comprising at least the second set of versions of the software component comprised by the software application, further comprise the instructions to cause the processor to perform static application security testing (SAST) on each version of the superset of versions of the software component comprised by the software application and obtaining a weakness presence indicator from the SAST.

20. A non-transient computer readable medium containing program instructions for causing a computer to perform a method of:
identifying a weakness in a software component comprised by a software application, wherein the software component comprised by the software application is one version of a plurality of versions of the software component, and wherein each version of the plurality of versions of the software component has a corresponding release date;
identifying a first set of versions of the software component that comprises the weakness, the first set of versions of the software component comprising the version of the software component comprised by the software application;
determining a code difference between (a) an earliest release date of a second set of versions of the software component that is absent the weakness and (b) a latest release date of the first set of versions of the software component that comprises the weakness;
generating a fix from the code difference;
selecting a target software component having a similar weakness; and
patching the target software component with the fix.
